(19) United States
(12) Patent Application Publication
(10) Pub. No.: US 2014/0240506 A1
(43) Pub. Date: Aug. 28, 2014

(54) Display System Layout for Remote Monitoring of Machines

(71) Applicant: CATERPILLAR INC., Peoria, IL (US)

(72) Inventors: Clarence Glover, Edwards, IL (US); Daniel Uphoff, Carlock, IL (US); Kent J. Chesko, Peoria, IL (US); Robert McGee, Peoria, IL (US); Brian G. Funke, Peoria, IL (US); Daniel K. Dunn, Dunlap, IL (US); Steven A. McKown, Dunlap, IL (US); Seth J. Redenbo, Metamora, IL (US)

(73) Assignee: CATERPILLAR INC., Peoria, IL (US)

(21) Appl. No.: 13/774,613

(22) Filed: Feb. 22, 2013

(51) Int. Cl. H04N 7/18

(52) U.S. Cl. CPC H04N 7/181
USPC 348/159

(57) ABSTRACT

A display system for presenting information relating to the remote monitoring and operation of machines is provided. The display includes a display screen configured to include a main section adapted to display video image data relating to a selected monitored machine. A first side section is arranged along a first edge of the display screen and adapted to display respective video image data associated with each of a plurality of monitored machines. A second side section is arranged along a second edge of the display screen and adapted to display video image data relating to a worksite.

### TECHNICAL FIELD

This patent disclosure relates generally to remote monitoring of machines and, more particularly, to a display system for monitoring information relating to the operation of such machines.

### BACKGROUND

Machines used in industries such as mining, construction and farming can operate in a variety of worksite environments. Such machines can include excavators, loaders, dozers, haul trucks, backhoes, motor graders, material handlers and the like. In some of these worksite environments, such as worksites in areas with extreme environmental conditions or in very remote areas, it may be desirable to remotely monitor and operate the machines as opposed to having an onboard operator. Moreover, in some circumstances depending on the tasks or jobs performed by the machines, it may be more efficient and cost effective to have a single operator monitor and operate multiple machines from a remote location.

In situations where a single operator is monitoring and operating multiple machines from a remote location, the machines may be configured to be operable semi-autonomously. More specifically, each machine may be operable in a remotely controlled mode where the remote operator directly controls one or more functions of the machine and in an autonomous operation mode where the machine is operating automatically. When remotely monitoring and controlling multiple machines, the remote operator may be called upon to simultaneously track multiple data streams associated with the multiple machines. This has the potential to overwhelm the operator with too much information leading to mental fatigue and a resultant loss in efficiency and/or productivity.

### SUMMARY

In one aspect, the disclosure describes a display system for presenting information relating to the remote monitoring of machines. The display includes a display screen configured to include a main section adapted to display video image data relating to a selected monitored machine. A first side section is arranged along a first edge of the display screen and adapted to display respective video image data associated with each of a plurality of monitored machines. A second side section is arranged along a second edge of the display screen and adapted to display video image data relating to a worksite in which the selected monitored machine and the plurality of monitored machines are operating.

In another aspect, the disclosure describes a display system for presenting information relating to the remote monitoring of machines. The display system includes a display screen configured to include a main section adapted to display a plurality of video image data sets each corresponding to a different point of view relative to a selected monitored machine. A first side section is arranged along a first edge of the display screen and adapted to display, for each of a plurality of monitored machines, a plurality of image data sets each image data set corresponding to a different point of view relative to a respective one of the plurality of monitored machines.

In yet another aspect, the disclosure describes a method for displaying information relating to the remote monitoring and operation of machines. The method includes the step of displaying a plurality of video image data sets each corresponding to a different point of view relative to a selected monitored machine in a main section of a display screen. For each of a plurality of monitored machines, a plurality of image data sets, each image data set corresponding to a different point of view relative to a respective one of the plurality of monitored machines, are displayed in a first side section arranged along a first edge of the display screen. Video image data relating to a worksite in which the selected monitored machine and the plurality of monitored machines are operating is displayed in a second side section arranged along a second edge of the display screen.

### BRIEF DESCRIPTION OF THE DRAWINGS

FIG. 1 is a schematic side view of an exemplary machine suitable for use with the display system of the present disclosure.

FIG. 2 is a schematic view showing a plurality of machines in communication with a remote operator console with a display system according to the present disclosure.

FIG. 3 is a schematic view of an exemplary layout for the screen of the display system of the present disclosure.

FIG. 4 is a schematic view of an alternative embodiment of a layout for the screen of the display system of the present disclosure.

### DETAILED DESCRIPTION

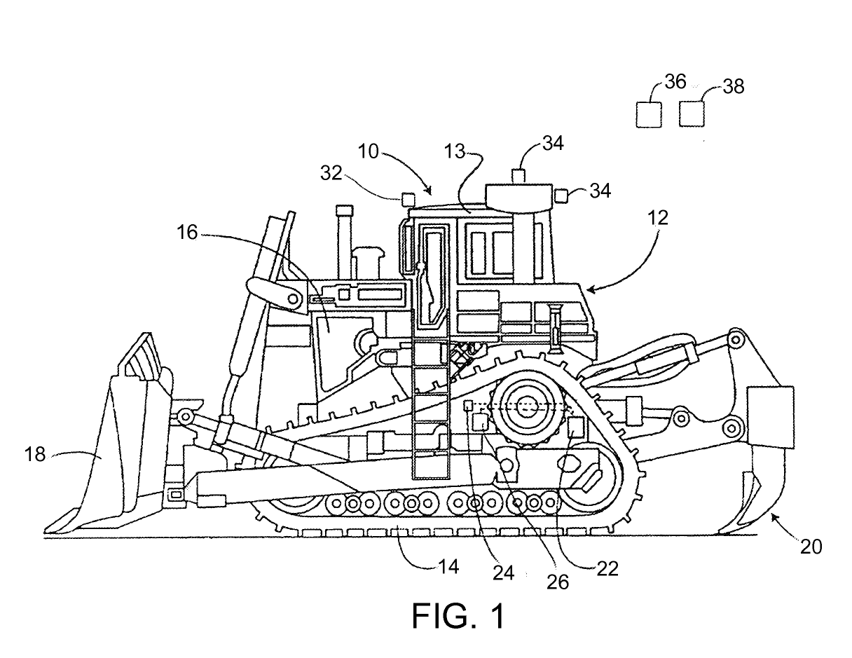

This disclosure generally relates to the remote monitoring of machines. More specifically, certain disclosed embodiments provide a display system for presenting information relating to the remote monitoring of a plurality of machines. Referring to FIG. 1, there is shown an exemplary machine 10, in this case a track type tractor, including a chassis 12 supporting an operator cab 13 and a pair of movable tracks 14 powered by an engine 16 with which the display system of the present disclosure may be implemented. The machine may include a work implement that may be supported on the front of the chassis 12. In the illustrated embodiment, the front work implement 18 is a blade that can be raised and lowered and otherwise positioned via actuators. Additionally, a second rear work implement 20, in this case a ripper, may be supported on the rear of the chassis 12.

While the display system of the present disclosure is described in connection with a tractor, the arrangement disclosed herein has universal applicability in various other types of machines as well. In this regard, the term “machine” may refer to any machine that performs some type of operation associated with an industry such as mining, construction, farming, transportation, or any other industry known in the art. For example, the machine may be an earth-moving machine, such as a wheel loader, track loader, bulldozer, excavator, dump truck, backhoe, motor grader, material handler or the like.

A controller 22, shown schematically in FIG. 1, may be provided to control the operation of the machine 10. The controller 22 may receive operator input command signals and control the operation of the various systems of the machine 10 including, for example, the engine 16 and the work implements 18, 20. The controller 22 may have one or more associated input devices to control the machine 10 and one or more associated sensors to provide data and other input signals representative of various operating conditions of the machine 10. The controller 22 may be mounted at any convenient location on machine 10. The controller 22 may be an electronic controller that operates in a logical fashion to perform operations, execute control algorithms, store and retrieve data and other desired operations. The controller 22 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller such as power supply circuitry, signal conditioning circuitry, driver circuitry, and other types of circuitry.

The controller 22 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 22 may be implemented in hardware and/or software without regard to the functionality. The controller 22 may rely on one or more data maps relating to the operating conditions of the machine 10 that may be stored in the memory of controller 22. Each of these maps may include a collection of data in the form of tables, graphs, and/or equations. The controller 22 may use the data maps to maximize the efficiency of the machine 10.

The machine 10 may be equipped with a plurality of sensors or sensing devices that gather data from various components and systems and generate signals that are directly or indirectly indicative of various machine parameters associated with the performance and operating conditions of the machine. Sensors may be associated with, for example, the engine 16, a transmission, the tracks 14, various actuators such as the actuators for the front and rear work implements 18, 20, fluid supplies, a parking brake and/or other systems and components of machine 10. These sensors may automatically gather real-time data such as the operation of engine 16, the position of and load on the work implements 18, 20, fluid pressure, flow rate, temperature, contamination level, and/or viscosity, fluid (i.e., fuel, oil, water, etc.) levels and consumption rates, electric current and/or voltage levels, engagement status of the parking brake, loading levels (e.g., payload value, percent of maximum allowable payload limit, payload history, payload distribution, etc.), transmission output ratio, and other desired information.

In addition, various sensors may be associated with the machine 10 that may be used to determine machine travel characteristics (e.g., speed, acceleration, torque, slip rate, etc.) as well as the position and orientation of machine 10. For example, a pitch rate sensor 24 (e.g., a gyroscope) may be provided on the machine 10. The pitch rate sensor 24 may be used to provide a pitch rate signal indicative of a pitch rate of the machine 10. As the machine 10 moves, the pitch rate will be indicative of the rate of change of the pitch angle of the machine. The pitch rate sensor 24 may also be used to determine the pitch angle and roll of the machine 10. Still further, an accelerometer may be provided on the machine 10 to provide an acceleration signal indicative of measured acceleration of the machine 10 relative to a gravity reference. In one example, the accelerometer may provide measurements in six degrees of freedom (i.e., fore-aft, lateral, and vertical directions as well as pitch, roll and yaw).

A position sensor 26 may also be provided to sense a position of the machine 10. The position sensor 26 may include a plurality of individual sensors that cooperate to indicate the position of the machine 10. The controller 22 may determine the position of the machine 10 as well as its orientation (i.e., the direction machine 10 is facing) based on information provided by the position sensor 26. In some instances, the position sensor 26 may be used to determine the pitch and roll of the machine 10. The position sensor 26 may be a series of global positioning system sensors, an odometer or other wheel rotation-sensing sensor, a perception based system or may use other systems such as lasers to determine the position of machine 10.

A camera system 28 may be provided for generating video image data relating to the machine 10. More specifically, the camera system 28 may be configured to provide video image data corresponding to at least one point of view relative to the machine 10. To this end, the camera system 28 may include one or more video cameras supported on the machine. For example, a plurality of cameras may be positioned to capture different views that an operator would have from within the operator cab 13 of the machine 10. The video cameras may be mounted at any suitable location on the machine 10. For example, as shown schematically in FIG. 1, one video camera 30 may be mounted such that it captures a video image of the area to the rear of the machine 10 and one video camera 32 may be mounted such that it captures a video image of the area to the front of the machine 10. Additionally, video cameras 34 (one of which is shown in FIG. 1) may be arranged so as to capture video images of the areas to either side of the side of the machine 10. With such an arrangement, each of the video cameras 30, 32, 34 may produce a video image data set that corresponds to a different point of view relative to the machine 10. In some embodiments, any of the video cameras 30, 32, 34 may be adjustably mounted such that the viewing angle of the video camera can be varied over a range of travel.

One or more site video cameras may also be provided to produce video image data relating to a worksite in which the machine is operating. One of the site video cameras may be configured as a machine tracking site video camera 36 that tracks the machine 10, using, for example, data provided by the position sensor on the machine 26, and moves automatically to follow the machine 10 as it moves within the worksite. One or more additional site video cameras 38 may be arranged to provide a broader view of the worksite. In this respect, each of the site video cameras 36, 38 may produce a video image data set that corresponds to a different point of view relative to the workplace.

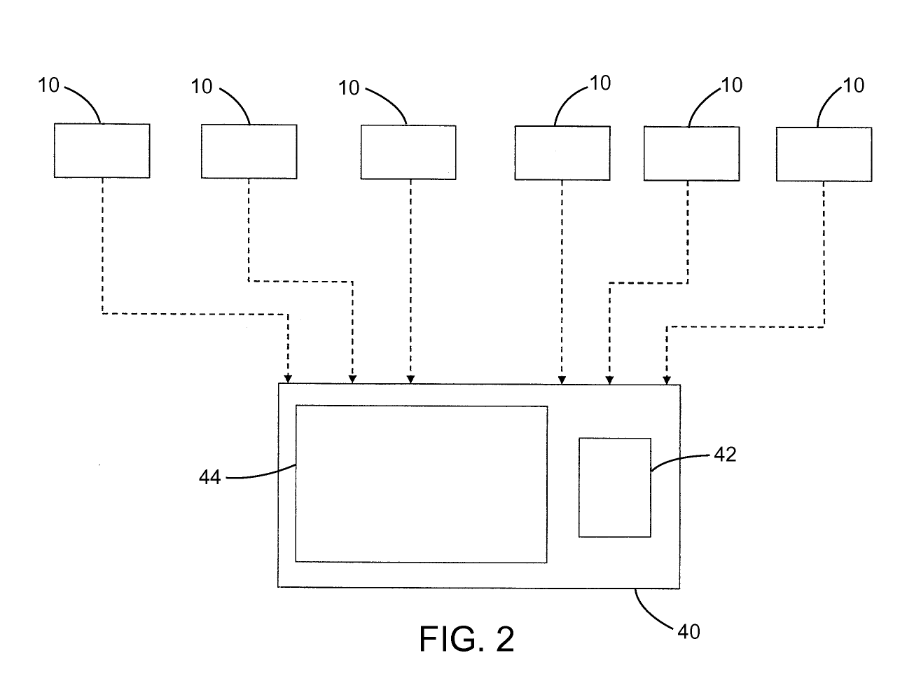

For enabling remote monitoring and/or operation of the machine, a remote operator console 40 (see FIG. 2) may be provided that may be in communication, such as via wireless communication, with the controller 22 and other systems on the machine 10. Further, the remote operator console 40 may be configured to remotely monitor a plurality of other machines 10 such as shown schematically in FIG. 2. The plurality of machines may include multiple machines similar to the machine 10 illustrated in FIG. 1 or it may include other types of machines such as, for example, a wheel loader, excavator, dump truck, backhoe, motor grader, material handler or the like. To facilitate semi-autonomous operation of the different machines 10 via the remote operator console 40, each machine 10, including for example its controller 22, may be configured such that it is operable in a remotely controlled mode and in an autonomous operation mode. In the remotely controlled mode, one or more functions of the machine 10 may be controlled by an operator stationed at the remote operator console 40. In the autonomous operation mode, the machine 10 may operate automatically as directed by the controller 22 and/or by some other control system. While in the autonomous operation mode, the machine 10 may be actively performing some function or be stopped, but in either case it is not under the direct control of the operator at the remote operator console 40. Instead, the operator may only monitor operation of a machine 10 in the autonomous operation mode through the remote operator console 40. It will be understood that the remote operator console 40 may be used to monitor any number of machines 10 operating in either the remotely controlled mode or the autonomous mode as may be permitted based on any limitations on the speed and volume of the data transfer to the remote operator console 40 and the operator's ability to process the data.

The remote operator console 40 may include one or more input devices 42 for providing commands or data input such as inputting information, changing operations, and issuing commands to one or more of the machine 10 through the remote operator console 40. The input devices 42 may include buttons, knobs, dials, levers, joysticks or the like. One or more of the input devices may have a fixed functionality such that they are always used to control the same function. Additionally, one or more of the input devices 42 may have a modifiable or changeable functionality such that they may be modified to control the input of different functions. Examples of modifiable function input devices 42 include a touch screen display with a computer-generated image, a knob, switch, button, pedal or joystick adjacent a computer display, or any other desired input device.

The remote operator console 40 may further include a display system 44 for presenting information to the remote operator relating to the remote monitoring of the plurality of machines 10. The information displayed may include the video image data produced by the camera systems 28 associated with each of the machines. To this end, the camera system 28 of each machine 10 may be configured to communicate its various video image data sets to the controller 22, which then communicates the data on to the remote operator console 40 or the camera system 28 may be configured to communicate directly with the remote operator console 40. In doing so, the video image data sets may be processed to some extent by the controller 22 at the machine 10 or processed by the remote operator console 40. The display system 44 may include a display screen 46 for displaying the images. The display screen 46 may comprise a liquid crystal device, a device based on light-emitting diodes or any other suitable display technology.

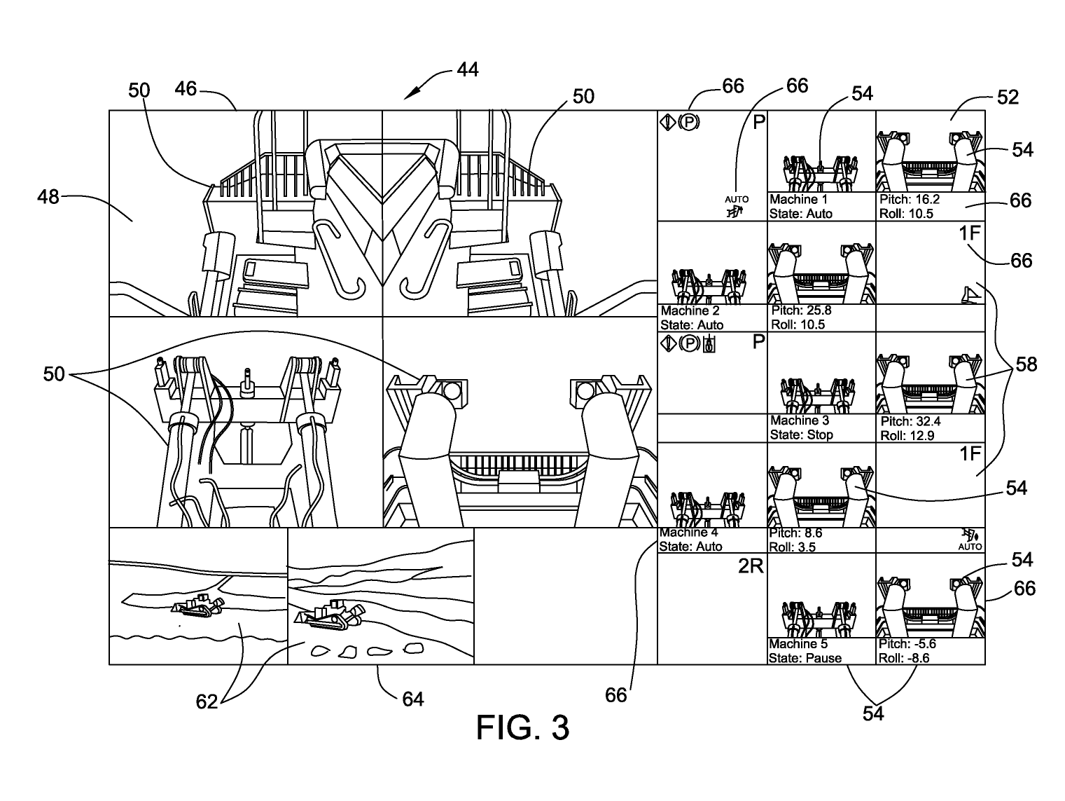

Referring to FIG. 3, the display screen 46 may be configured with a plurality of different areas for presenting different information to the operator. For example, the display screen 170 may include a main section 48 that is adapted to display video image data 50 relating to a selected monitored machine 10. This video image data 50 may include the plurality of video image data sets produced by the video cameras 30, 32, 34 mounted on the machine 10 such that the different points of view relative to the machine 10 produced by the cameras are presented in the main section 48. As shown in the illustrated embodiment, the main section 48 may be divided into four windows with each presenting the video image data 50 set associated with a different point of view relative to the machine 10. In this case, right and left views relative to the machine 10 are provided in the upper two windows of the main section 48 and front and back views relative to the machine 10 are provided in the lower two windows of the main section 48. The machine 10 selected for display in the main section 48 may be operating in the remotely controlled mode or the autonomous operation mode. If the machine 10 is operating in the remotely controlled mode, the operator at the remote operator console 40 may control operation of one or more functions of the machine such as through the input devices 42. If the machine 10 is operating in the autonomous mode, the operator may be more closely monitoring autonomous operation of the machine using the video image data 50 presented in the main section 48.

The display screen 46 may also include a first side section 52 that may be adapted to display video image data 54 associated with each of a plurality of monitored machines 10, such as is produced by one or more of the video cameras 30, 32, 34 that may be provided on the respective machines 10. The first side section 52 may be arranged along a first edge 56 of the display screen 46, such as, for example, the right side edge of the display screen 46 as shown in the embodiment of FIG. 3. Further, the first side section 52 may include a plurality of subsections 58 with each subsection 58 corresponding to a respective one of the plurality of monitored machines 10. In the embodiment illustrated in FIG. 3, these subsections 58 are arranged in vertically stacked relation. The subsection 58 associated with each autonomously operating machine 10 may be adapted to display a plurality of video image data 54 sets each of which corresponds to a different point of view relative to the respective machine 10. For instance, as shown in FIG. 3, the forward and rearward video camera images for each of the monitored machines 10 may be displayed in each of the subsections 58 of the first side section 52. In the illustrated embodiment, the first side section 52 is divided into five subsections 58 because the remote operator console 40 is configured to monitor up to five different machines 10 in the first side section 52. Of course, the first side section 52 could be configured to display information relating to any number of machines 10 depending on the size of the display screen 46 and the size of the displayed video images. Moreover, the first side section 52 could be configured so as to allow the remote operator to scroll through the video image data for any number of machines with a certain number, for example five, being able to be displayed at any given time, but with the operator having the ability to change, as desired, the particular machines being displayed.

The display screen 46 may further include a second side section 60 that is adapted to display video image data 62 relating to the worksite in the which the plurality of machines 10 are operating, such as may be produced by the one or more of the site cameras 36, 38 that may be provided. The second side section 60 may be arranged along a second edge 64 of the display screen 46. For example, as shown in FIG. 3, the second side section 60 may be arranged along a bottom edge of the display screen 46 below the main section 48 and adjacent the first side section 52. The video image data 62 relating to the worksite presented in the second side section 60 may include a plurality of video image data sets each corresponding to a different point of view relative to the worksite. For example, one video image data 62 set may be provided by the machine tracking site video camera 36 while another may be provided by the site camera 38 providing a broader view of the work site. In the FIG. 3 embodiment, the two video images are in side-by-side relation in the second side section 60 with a third window also being provided that may be used to provide an additional site video feed or other information but, in this case, is left blank. The second side section 60 could be configured so as to allow the remote operator to scroll through the video image data associated with any number of different worksite video cameras with a certain number, for example three, being able to be displayed at any given time, but with the operator having the ability to change, as desired, the particular site cameras being displayed.

When the operator at the remote operator console switches the selection for display in the main section 48 from one machine to another, the video image data relating to the previously controlled machine will shrink down and move from the main section 48 to the first side section 52. Additionally, the image data relating to the newly selected machine 10 will move from the first side section 52 to the main section 48. The video image data 62 produced by the site video cameras 36, 38 can be displayed on the main section 48 in situations where none of the machines 10 are selected by an operator at the remote operator console 40 for display in the main section. Alternatively, the main section 48 may remain blank when no machine 10 is selected for display in the main section 48. The display system may further be configured such that, when desired by an operator, the main section 48 may be expanded to take up the entire or nearly the entire display screen 46 with the first side section 52 and the second side section 60 being removed or overlaid by the main section 48.

In addition to providing video image data 50, 54, the main section 48 and the first side section 52 may be configured to display machine parameter information 66 relating to each of the plurality of machines 10 in communication with the remote operator console 40. More specifically, machine parameter information 66 regarding the selected monitored machine 10 may be displayed in the main section 48 while machine parameter information 66 relating to each of the plurality of other machines 10 may be displayed in the first side section 52. In the embodiment of FIG. 3, the subsection 58 for each of the plurality of machines 10 displayed in the first side section 52 is divided into three windows with one window providing only machine parameter information 66 while the other two windows provide both video image data 54 and machine parameter information 66. The machine parameter information 66 may be communicated by the controller 22 on the machine 10 and may include, for example as shown in FIG. 3, an indication of the gear in which the transmission is operating, pitch and roll values for the machine (e.g., based on the pitch rate sensor 24 readings), the machine status (e.g., auto or stop), as well as other indicators that may be provided on the instrumental panel of a machine 10 such as warning lights, parking brake engagement indicators and work implement 18, 20 lockout indicators. Other machine parameter information 66 that may be displayed includes the temperature of various fluids, the fuel level, the pressure of machine fluids, the load weight, machine speed, machine type and any other type of information related to the machine 10 and/or machine operations.

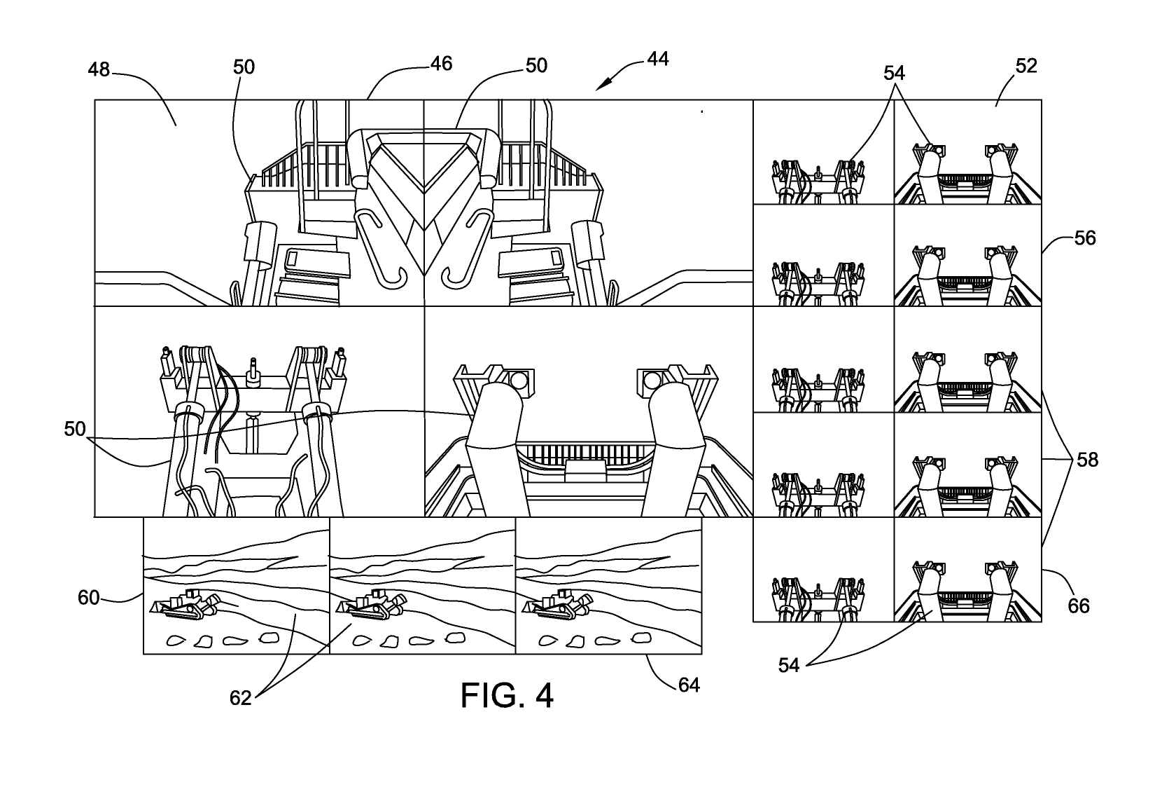

An alternative embodiment of a layout for the display screen 46 is shown in FIG. 4, with the same reference numbers used in FIG. 3 being used to refer to like elements. The layout shown in FIG. 4 is generally similar to the one shown in FIG. 3 except that the windows for displaying the various video image data sets, and particularly the four windows in the main section 48, have an approximately 16:9 aspect ratio. Of course, it will be understood that while the windows have that aspect ratio, they may also display image data having a different aspect ratio. In the embodiment of FIG. 4, only two windows are provided in each of the subsections 58 of the first side section 52. However, it will be appreciated that different numbers and configurations of windows may be used. The side section 52 in the FIG. 4 embodiment also does not include the display of any machine parameter information. Machine parameter information could be displayed around the video image data (as done in the FIG. 3 embodiment) or overlaid on the video images themselves.

### INDUSTRIAL APPLICABILITY

The present disclosure is applicable to the remote monitoring of any type of machine. The disclosure is particularly applicable to the remote monitoring of a plurality of machines by a single operator at a remote operator console. The display system of the present disclosure can present information about both a selected one of the machines and the rest of the machines being monitored by the operator in quickly understandable layout. The layout of the display screen presents this information in a manner that avoids overloading the operator with too much information and can thereby help prevent operator mental fatigue. Thus, the monitoring of the machines through the operator console may be more efficient and productive.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A display system for presenting information relating to the remote monitoring of machines, the display system comprising:
a display screen configured to include:
a main section adapted to display video image data relating to a selected monitored machine;
a first side section arranged along a first edge of the display screen and adapted to display respective video image data associated with each of a plurality of monitored machines; and
a second side section arranged along a second edge of the display screen and adapted to display video image data relating to a worksite in which the selected monitored machine and the plurality of monitored machines are operating.

2. The display system according to claim 1 wherein the video image data that the main section is adapted to display includes a plurality of video image data sets each corresponding to a different point of view relative to the selected machine.

3. The display system according to claim 1 wherein the video image data that the first side section is adapted to display includes, for each of the plurality of monitored machines, a plurality of image data sets each image data set corresponding to a different point of view relative to a respective one of the plurality of machines.

4. The display system according to claim 1 wherein the video image data that the second side section is adapted to display includes a plurality of video image data sets each corresponding to a different point of view relative to the worksite.

5. The display system according to claim 1 wherein the main section is adapted to display machine parameter information relating to the selected monitored machine.

6. The display system according to claim 1 wherein the first side section is adapted to display respective machine parameter information relating to each of the plurality of monitored machines.

7. The display system according to claim 1 wherein the first edge and the second edge of the display screen are adjacent each other.

8. The display system according to claim 1 wherein the first side section includes a plurality of subsections with each subsection being adapted to display image data associated with a respective one of the plurality of monitored machines.

9. The display system according to claim 1 wherein the main section is further adapted to display image data relating to the worksite.

10. A display system for presenting information relating to the remote monitoring of machines, the display system comprising:
a display screen configured to include:
a main section adapted to display a plurality of video image data sets each corresponding to a selected monitored machine; and
a first side section arranged along a first edge of the display screen and adapted to display, for each of a plurality of monitored machines, a plurality of image data sets each image data set corresponding to a different point of view relative to a respective one of the plurality of monitored machines.

11. The display system according to claim 10 further including a second side section arranged along a second edge of the display screen and adapted to display video image data relating to a worksite in which the selected monitored machine and the plurality of monitored machines are operating.

12. The display system according to claim 11 wherein the video image data that the second side section is adapted to display includes a plurality of video image data sets each corresponding to a different point of view relative to the worksite.

13. The display system according to claim 10 wherein the main section is adapted to display machine parameter information relating to the selected monitored machine.

14. The display system according to claim 10 wherein the first side section is adapted to display respective machine parameter information relating to each of the plurality of monitored machines.

15. The display system according to claim 10 wherein the first edge and the second edge of the display screen are adjacent each other.

16. The display system according to claim 10 wherein the first side section includes a plurality of subsections with each subsection being adapted to display image data associated with a respective one of the plurality of monitored machines.

17. The display system according to claim 10 wherein the main section is further adapted to display image data relating to the worksite.

18. A method for displaying information relating to the remote monitoring of machines, the method comprising:
displaying a plurality of video image data sets each corresponding to a different point of view relative to a selected monitored machine in a main section of a display screen;
displaying for each of a plurality of monitored machines a plurality of image data sets each image data set corresponding to a different point of view relative to a respective one of the plurality of monitored machines in a first side section arranged along a first edge of the display screen; and
displaying video image data relating to a worksite in which the selected monitored machine and the plurality of monitored machines in a second side section arranged along a second edge of the display screen.

19. The method according to claim 18 further including the step of displaying machine parameter information relating to the selected machine in the main screen section.

20. The method according to claim 18 further including the step of displaying in the first side section respective machine parameter information relating to each of the plurality of monitored machines.
